(19) United States
(12) Patent Application Publication
(10) Pub. No.: US 2006/0109775 A1
(43) Pub. Date: May 25, 2006

(54) Using spot differentials to determine mark quality

(76) Inventors: Lawrence N. Taugher, Loveland, CO (US); Kevin L. Colburn, Greeley, CO (US); Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/996,150

(22) Filed: Nov. 23, 2004

(51) Int. Cl. G11B 7/24; G11B 5/09

(52) U.S. Cl. 369/275.1; 369/59.1; 369/47.1

(57) ABSTRACT

A method comprising; installing a written media that contains marks and un-written areas, scanning the written marks and un-written areas concurrently, and determining the quality of the marks by determining a delta optical density.

### BACKGROUND OF THE INVENTION

1. Field of the Invention

A method comprising; installing a written media that contains marks and un-written areas, scanning the written marks and un-written areas concurrently, and determining the quality of the marks by determining a delta optical density.

2. Description of the Related Art

Optical disks represent a significant percentage of the market for data storage of software as well as of photographic, video, and/or audio data. Typically, optical disks have data patterns embedded thereon that can be read from and/or written to one side of the disk, and a graphic display/mark or label printed on the other side of the disk. Prior to the present invention, as set forth in general terms above and more specifically below, it is known in the CD/DVD art, that optical disks represent a significant percentage of the market for data storage of software as well as for photographic, video, and/or audio data. Typically, optical disks have data patterns embedded thereon that can be read from one or both side(s) of the disk, and a graphic display/mark printed on the other side of the disk. The data readable side, or data side, of the disk contains a spiral track of variably spaced depressions, called pits, separated by un-depressed surface areas, called lands. A low-powered laser is focused onto the spiral track. The height difference between pits and lands creates a phase shift in the reflected beam that may be measured and translated into usable data. Various optical disk formats include, but are not limited to, CD, CD-ROM, CD-R, CD-RW, DVD, DVD-R, and DVD-RW.

In order to identify the contents of the optical disk, printed patterns or graphic displays/marks can be printed on the non-data side of disk. The patterns or graphic displays can be both decorative and provide pertinent information about the data content of the disk. Labeling of the optical disk has in the past been routinely accomplished through a variety of printing methods. While these printing methods are capable of producing a graphic display/mark on the disk, it is routinely difficult to determine the quality of the graphic display or mark made on the disk. This is due to the small differences in the reflectivities between disks containing high-quality marks and unwritten disks that contain no marks. The reason for this is that chemistry was tuned/designed to absorb the wavelength of the laser (780 nm) to create heat and cause a chemical reaction that changes the color. When looking at the mark that was just created with low-power, the chemistry still absorbs the low laser power so very little of the light is available to be reflected. Also, increasing this difficulty is that the small difference is buried in the signal noise because of irregularities in the media surface. Therefore, a more advantageous system, then would be presented if the quality of the mark on the disk could be indirectly and accurately determined.

It is apparent from the above that there exists a need in the optical disk art for a system that is capable of indirectly determining if a mark has been placed upon an optical disk and at the same time determining the quality of that mark. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a method comprising; installing a written media that contains marks and un-written areas, scanning the written marks and un-written areas concurrently, and determining the quality of the marks by determining a delta optical density.

In certain preferred embodiments, the delta optical density is determined by using at least two satellite photo diodes.

In another further preferred embodiment, the present invention provides a method for indirectly and accurately determining the quality of a mark placed upon a media, such as an optical disk.

The preferred media mark detection system, according to various embodiments of the present invention, offers the following advantages: ease of use, excellent mark determination characteristics, excellent signal noise reduction characteristics, and excellent economy. In fact, in many of the preferred embodiments, these factors of excellent mark determination characteristics, excellent signal noise reduction characteristics, and excellent economy are optimized to an extent that is considerably higher than heretofore achieved in prior, known media mark detection systems.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of a system for scanning a substrate, according to an embodiment of the invention;

FIG. 2 is a diagram showing how the photo diodes are superimposed on marks that have been made on the media for label side sensing/reading of media, according to an embodiment of the invention; and

FIG. 3 is a flowchart of a method for scanning a substrate, according to an embodiment of the invention.

### DETAILED DESCRIPTION OF THE INVENTION

In describing and claiming the present invention, the following terminology will be used.

As used herein, “media” is meant to encompass any coatable surface, composed of wood, plastic, clay, paper, polymers, metals etc. One example is audio, video, multimedia, and/or software disks that are machine readable in a CD and/or DVD drive, or the like. Examples of optical disk formats include writable, recordable, and rewritable disks.

As used herein, “mark” can include any visible character or image found on a media or any surface used for viewing and conveying information. For example, the mark is found prominently on one side of the optical disk, but this is not always the case.

As used herein, “data” is typically used to include the non-graphic information contained on the optical disk that is digitally or otherwise embedded therein. Data can include audio information, video information, photographic information, software information, or the like.

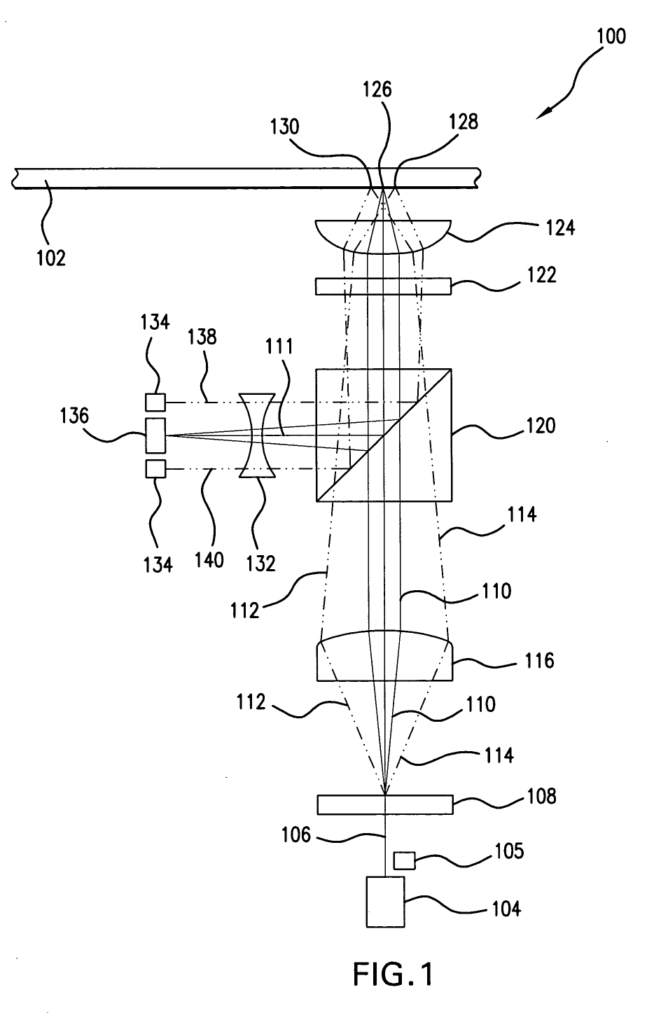

FIG. 1 shows an optical-mechanical system 100, according to an embodiment of the invention. The system 100 is used for scanning the label side of media 102. A laser diode 104 outputs laser light 106 that a diffraction grating 108 separates into a number of laser beams 110, 112, and 114. A conventional forward sense diode 105 is utilized to monitor the power of laser light 106. Typically, the laser is a 400 to 800 nm laser operated over a power range of 0.01 to 100 mW. Preferably, the laser is operated over a power range of 1-5 mW for read operations and 25-60 mW for write operations. The separation of the laser 106 into the laser beams 110, 112, and 114 can be accomplished by using other well-known mechanisms than diffraction grating 108. The laser beams 110, 112, and 114 pass through a collimator lens 116 to collimate the beams 110, 112, and 114 and then through a polarizing beam splitter 120. Laser beams 110, 112, and 114 are then passed through a quarter wave plate 122 that rotates laser beams 110, 112 and 114 such that returning laser beams 111, 138, and 140, respectively are redirected by polarizing beam splitter 120 towards satellite photo diodes 134 and quad photo diodes 136, as will be discussed later. After being rotated in quarter wave plate 122, objective lens 124 is used to focus the laser beams 110, 112, and 114 onto a number of tracks on the label side of the optical disc 102, as indicated by the reflection points 126, 128, and 130, respectively.

The tracks of the label side of the media 102 reflect the laser beams 138 and 140, which are directed back through the objective lens 124 to quarter wave plate 122. Quarter wave plate 122 again rotates beams 111, 138, and 140 such that they can be redirected by polarizing beam splitter 120 towards satellite photo diodes 134 and quad photo diodes 136 after passing through cylindrical lens 132. It is to be understood that laser beam 110 perpendicularly impinges upon quarter wave plate 122. This causes laser beam 110 to perpendicularly impinge upon optical disk 102. Upon reflection of laser beam 110 at reflection point 126, laser beam 111 is reflected perpendicularly upon quarter wave plate 122, through polarizing beam splitter 120, through cylindrical lens 132, and impinges quad photo diode 136. There is preferably an individual satellite photo diode 134 for each of the beams 138 and 140. The satellite photo diodes 134 thus sense the beams 138 and 140 as they are reflected off the label side of the media 102.

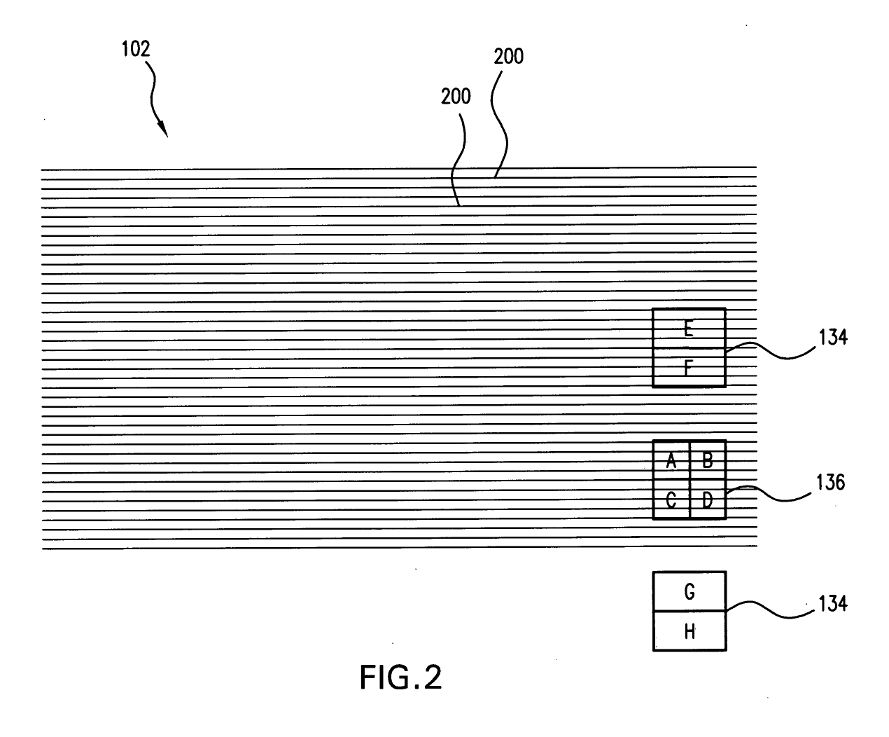

With respect to FIG. 2, photo diodes 134 and 136 are superimposed on marks 400 that have been made on the media 102 for label side scanning of media 102. As can be seen in FIG. 2, one of the satellite photo diodes 134 is located so as to receive signals from marks 200 while the other satellite photo diode 134 is located so as to receive signals from unwritten areas of media 102. When applying the delta optical density equation in FIG. 2, the quality of the marks 200 can be determined through the signal measurements taken at elements E and F and G and H of satellite photo diodes 134. It is to be understood that the distance between the two satellite photo diodes 134 is small in comparison to the physical dimensions of the grooved surface of media 102. As discussed above, the undesirable signal noise is a result of the irregularities in the media surface. However, at a microscopic level, the noise is substantially reduced or eliminated because the satellite photo diodes 134 do not sense the irregularities in the media surface. In short, the satellite photo diodes 134 see the same noise. However, the satellite photo diode 134 that is located so as to receive signals from marks 200 will produce a signal while the satellite photo diode 134 located so as to receive signals from the unwritten areas of media 102 should not produce a signal. In this manner, the actual signal difference between the satellite photo diodes 134 can be determined which will provide a delta optical density and, therefore, an indication as to the quality of marks 200 upon media 102.

It is to be understood that the laser beams 110, 112, and 114 may serve a number of different purposes. When separated from a high power laser 104, the beams 110, 112, and 114 can be used to write to the label side of the media 102. When separated from a lower-power laser 104, the beams 110, 112, and 114 can be used to read from the label side of the media 102. Such reading may include the sensing of the label side of the media 102 that has been described.

Changes to the system 100 can also be made without departing from the spirit or scope of the invention. For instance, in one embodiment, a physical and/or optical ninety-degree rotation of the photo diodes 134 and 136 may be accomplished. As another example, the photo diodes 134 and 136 may be physically or optically rotated more or less than ninety degrees for optimizing image quality or other aspects and attributes of the system 100.

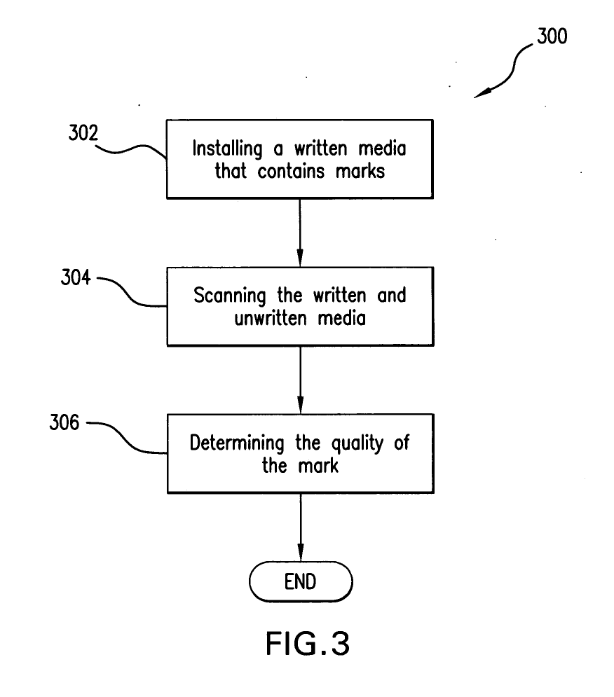

With respect to FIG. 3, there is illustrated a method 300 for using spot differentials to determine mark quality. Method 300 includes, in part, the steps of: installing a written media that contains marks and un-written areas (step 302); scanning the written and un-written media (step 304); and determining the quality of the mark (step 306).

With respect to step 304, after the written media 102 (FIG. 1) has been installed, system 100 is used to scan the media 102. As discussed above, this scanning will result in a signal that contains information regarding the marks 200 and the un-written areas (FIG. 2). After the written and un-written media has been scanned, the signals in the satellite photo diodes 134 can be subtracted in a conventional computing device (not shown) to determine the delta optical density resulting from the measurements of the graphic display or mark located upon the written media, as shown in step 306.

It is to be understood that the flowchart of FIG. 3 shows the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiment of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Although the flowchart of FIG. 3 shows a specific order of execution, the order of execution may differ from that which is depicted. For example, the order of execution of two or more blocks may be scrambled relative to the order shown. Also, two or more blocks shown in succession in FIG. 3 may be executed concurrently or with partial concurrence. All such variations are within the scope of the present invention.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method comprising:
installing a written media that contains marks and un-written areas;
scanning the written marks and un-written areas concurrently; and
determining the quality of the marks by determining a delta optical density.

2. The method of claim 1, wherein the media scanning step is further comprised of the step of:
using a laser to scan the media.

3. The method of claim 2, wherein the laser is operated at a power range of 0.01-100 mW.

4. The method of claim 3, wherein the laser is operated at a power range of 1-5 mW for read operations and 25-60 mW for write operations.

5. The method of claim 1, wherein the determining step is further comprised of the steps of:
measuring a reflectivity of a mark;
measuring a reflectivity of an unwritten portion of the media; and
comparing the two reflectivities to determine the delta optical density.

6. An apparatus for using spot differentials to determine mark quality comprising:
a laser having at least two beams incident upon a track of a label side of a media;
a plurality of sensors operatively connected to the laser for detecting a mark and an un-written area on the media; and
a computing device operatively connected to the sensor for determining a quality of the mark through a delta optical density measurement.

7. The apparatus of claim 6, wherein the laser is further comprised of:
a 780 nm laser.

8. The apparatus of claim 6, wherein the laser is further comprised of:
a 650 nm laser.

9. The apparatus of claim 6, wherein the laser is further comprised of:
a 405 nm laser.

10. The apparatus of claim 6, wherein the sensors are further comprised of:
at least two satellite photo diodes located at a predetermined distance away from each other.

11. A computer-readable medium having a computer program stored thereon for performing a method comprising:
installing a written media that contains marks and un-written areas;
scanning the written marks and un-written areas concurrently; and
determining the quality of the marks by determining a delta optical density.

12. The method of claim 11, wherein the media scanning step is further comprised of the step of:
using a laser to scan the media.

13. The method of claim 12, wherein the laser is operated at a power range of 0.01-100 mW.

14. The method of claim 13, wherein the laser is operated at a power range of 1-5 mW for read operations and 25-60 mW for write operations.

15. The method of claim 11, wherein the determining step is further comprised of the steps of:
measuring a reflectivity of a mark;
measuring a reflectivity of an unwritten portion of the media; and
comparing the two reflectivities to determine the delta optical density.

16. A system comprising:
means for installing a written media that contains marks and un-written areas;
means for scanning the written marks and un-written areas concurrently; and
means for determining the quality of the marks by determining a delta optical dens

17. The system of claim 16, wherein the media scanning means is further comprised of the step of:
means for using a laser to scan the media.

18. The system of claim 17, wherein the laser means is operated at a power range of 0.01-100 mW.

19. The system of claim 18, wherein the laser means is operated at a power range of 1-5 mW for read operations and 25-60 mW for write operations.

20. The system of claim 16, wherein the determining means is further comprised of the steps of:
means for measuring a reflectivity of a mark;
means for measuring a reflectivity of an unwritten portion of the media; and
means for comparing the two reflectivities to determine the delta optical density.
